(19) United States
(12) Patent Application Publication
(10) Pub. No.: US 2002/0049703 A1
(43) Pub. Date: Apr. 25, 2002

(54) Advertisement distribution system and method in sport broadcasting

(76) Inventor: Mitsunari Uozumi, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/776,660

(22) Filed: Feb. 6, 2001

(30) Foreign Application Priority Data
Jul. 27, 2000 (JP) 2000-226695

(51) Int. Cl. G06F 7/00

(52) U.S. Cl. 707/1

(57) ABSTRACT

An advertisement distribution system comprises a player information database comprising player information including a profile of a team or player participating a tournament; and a sponsor database containing ID information of a company to sponsor a match, registered so as to correspond to match information including an opponent, and data and time of the match. A page for advertisement determination processing section registers in the sponsor database ID information of a company so as to correspond to a match involving a team designated by the company, based on the content set in the player information database. An advertisement insertion processing section specifies a sponsor in the sponsor database, for a match aired in each broadcast page created, and extracts an advertisement of the sponsor from an advertisement master for insertion into a corresponding broadcast page. With the above, the advertisement distribution system places in sports broadcasting an advertisement suited to the tendency or preference of sports viewers.

### BACKGROUND OF THE INVENTION

1. Field of the Invention

The present invention relates to an advertisement distributing system and method employed in sports broadcasting, and in particular to an advertisement distribution method employed in live broadcasting, via the Internet, of a sport in which many players or teams from many countries compete (such as the America's Cup or the Olympics) in match-style games (such as yacht races) or in which many players compete simultaneously (such as a marathon).

2. Description of the Related Art

In a sports tournament, e.g., the America's Cup, where many teams from a plurality of countries compete against one another, a plurality of yacht teams compete in an all-play-all race system to determine a challenging yacht. In this case, two or more match races are carried out in parallel. In TV broadcasting, a particular race is focused on and players involved in the race are equally covered, with a sponsor's advertisement being shown throughout the whole tournament.

Presently, sport tournaments are aired via the Internet, so that an Internet user (i.e., a viewer) can chose a desired broadcast page from among a plurality of broadcast pages airing the respective match races. This allows a viewer to select a race he would like to watch according to his preference, whereas TV broadcasting airs only a one-sidedly selected race.

FIG. 4 is a schematic structural diagram of a sport broadcasting system employing a conventional advertisement distribution system, for live broadcasting of sports and so on. This system comprises a camera 1 for shooting games, an image collection device 2 for collecting images from the camera 1, and a broadcast page creation device 4 for creating a broadcast page based on the collected images and incorporating tournament sponsor information 3 into a broadcast page.

Here, operation of a conventional advertising system for Internet broadcasting will be briefly described. The image collection device 2 collects images of each race from each camera 1. The broadcast page creation device 4 creates a broadcast page for each race based on the collected images. In the creation, an advertisement of a particular sponsor is inserted into each broadcast page based on the sponsor information 3 according to various conditions including a broadcast time band, a broadcast frequency, and so on. In the example of FIG. 4, an advertisement X of a certain company is inserted into each of the broadcast pages 5 covering the respective games 1 to n carried out in parallel. A viewer can select and watch a desired broadcast page from all created broadcast pages 5.

Relatively well known sports tournaments, particularly, international ones, such as the Olympics, the America's Cup, the World Cup, and so on, are considered excellent opportunities for companies to advertise around the whole world. No small number of companies are willing to pay a large amount of contract fees to sponsor such tournaments. Once they become sponsors, their advertisements are shown in the respective broadcast pages covering the respective races, which contributes significantly to increasing brand fame of the sponsor companies around the world.

However, a conventional advertisement system for sport broadcasting via the Internet does not always guarantee the sponsors effective advertisement or advertisement effects commensurate with the costs paid by the sponsors, for the following reasons.

It is indeed preferable in view of company strategy to be a sponsor because of the benefit of being given an opportunity to advertise its own brand all around the world throughout the tournament. However, such advertisement may also directed to Internet users who cannot be customers of the advertising companies, in other words, from whom advertisement effects cannot be expected. For example, advertisement may be placed in a program of a game to be watched by people in a country with no sales outlet of the advertising company. Conventionally, companies are requested to contract with a tournament committee to sponsor the whole tournament. Such a contract is generally a package which may be ranked only roughly with coverage over even a race in which companies do not particularly wish to advertise. In other words, companies have no other choice but to advertise uniformly in the respective races irrespective of the expected effectiveness of the advertisement, even though this may go against the nature of advertising in that contents suited to the tendency and preference of targeted viewers should normally be aired in an advertisement. Such advertisements may not always guarantee an effective result.

Meanwhile, for general viewers, it is preferable that only information useful to them be provided, rather than being exposed to all advertisement including ones totally out of their range of interest, which, however, may happen in the above described conventional advertisement system.

### SUMMARY OF THE INVENTION

The present invention has been conceived to solve the above problems, and aims to provide an advertisement distribution system and method to be employed in sports broadcasting, capable of placing, in sport broadcasting, an advertisement suited to the tendency or preference of a viewer of the sports broadcasting.

In order to achieve the above object, according to the present invention, there is provided a method for distributing advertisement in sport broadcasting, which is employed in a sport broadcasting system for live broadcasting of a sports competition in which a plurality of teams or players compete in parallel, through collecting image data obtained using a plurality of image capturing devices, creating a plurality of broadcast pages based on the image data collected for disclosure via the Internet, and having a viewer select a desired page to watch from the plurality of broadcast pages created. This method comprises the step of: setting an advertisement to be shown on each broadcast page, for every broadcast page created.

Further, according to another aspect of the present invention, there is provided another method for distributing advertisements in sports broadcasting, which is employed in a sports broadcasting system for live broadcasting of a sports competition in which a plurality of teams or players compete in parallel, through collecting image data obtained using a plurality of image capturing devices, creating a plurality of broadcast pages based on the image data collected for disclosure via the Internet, and having a viewer select a desired page to watch from the plurality of broadcast pages created. This method comprises the steps of: recognizing a team or a player to be aired in each broadcast page created, and setting an advertisement to be shown corresponding to a team or a player.

The advertisement distribution system according to the present invention is employed in a sports broadcasting system for live broadcasting of a sports competition in which a plurality of teams or players compete in parallel, through collecting image data obtained using a plurality of image capturing devices, creating a plurality of broadcast pages based on the image data collected for disclosure via the Internet, and having a viewer select a desired page to watch from the plurality of broadcast pages created, and distributes advertisements by inserting into a broadcast page created.

This advertisement distribution system comprises advertisement insertion processing means for inserting an advertisement into a broadcast page created; a player information database containing registered player information including a profile of a participating team or player; a sponsor database containing content of a competition to be aired on each broadcast page, and sponsor ID information of a sponsor placing an advertisement, both being registered in correspondence with each other, page for advertisement determination processing means for causing display of the player information registered in the player information database, letting a sponsor designate a team or a player in which to place an advertisement, and registering the sponsor ID information to the sponsor database so as to correspond to a broadcast page airing the content of competition involving the team or player designated, wherein the advertisement insertion processing means specifies a sponsor for each broadcast page created, based on content set in the sponsor database, and inserts an advertisement of the sponsor specified into a corresponding broadcast page.

Another advertisement distribution system according to another aspect of the present invention is employed in a sports broadcasting system for live broadcasting of a sports competition in which a plurality of matches involving teams or players are played in parallel, through collecting image data obtained using a plurality of image capturing devices, creating a plurality of broadcast pages based on the image data collected for disclosure via the Internet, and having a viewer select a desired page to watch from the plurality of broadcast pages created, and distributing advertisement by inserting into a broadcast page created.

The advertisement distribution system comprises advertisement insertion processing means for inserting an advertisement to a broadcast page airing each match; a sponsor database containing sponsor ID information corresponding to match information on each match; and page for advertisement determination processing means, for registering sponsor ID information in the sponsor database, wherein the advertisement insertion processing means specifies a sponsor for each match to be aired in each broadcast page, based on content set in the sponsor database, and inserts an advertisement of the sponsor specified into a corresponding broadcast page.

The page for advertisement determination processing means specifies a match involving a team or a player designated by the sponsor in the sponsor database, and registers the sponsor ID information in the sponsor database so as to correspond to the match specified.

The advertisement distribution system further comprises a player information database containing player information including a profile of an involved team or player. The page for advertisement determination processing means causes display of player information registered in the player information database, lets the sponsor designate a team or a player for which to place an advertisement, specifies a match in the sponsor database, which involves the team or player designated by the sponsor, and registers in the sponsor database the sponsor ID information so as to correspond to a broadcast page airing content of a competition involving the team or player designated.

According to the present invention, sponsors are raised for every broadcast page airing a sports game, rather than for the whole tournament, and their advertisements are aired accordingly. This allows more targeted advertising.

Also, as advertisements may be placed corresponding to a team or a player, a sponsoring company may effectively place advertisements appropriate to the tendency or preference of their target viewers.

### BRIEF DESCRIPTION OF THE DRAWINGS

The above and other objects, features, and advantages of the present invention, will become further apparent from the following description of the preferred embodiment taken in conjunction with the accompanying drawings wherein:

FIG. 1 is a schematic structural diagram showing a sports broadcasting system employing a preferred embodiment of an advertisement distribution system for sports broadcasting according to the present invention;

FIG. 2 is a diagram showing an exemplary data structure of a sponsor database in the preferred embodiment;

FIG. 3 is a diagram showing an exemplary data structure of a player information database in the preferred embodiment; and

FIG. 4 is a schematic structural diagram showing a sports broadcasting system employing a conventional advertisement distribution system.

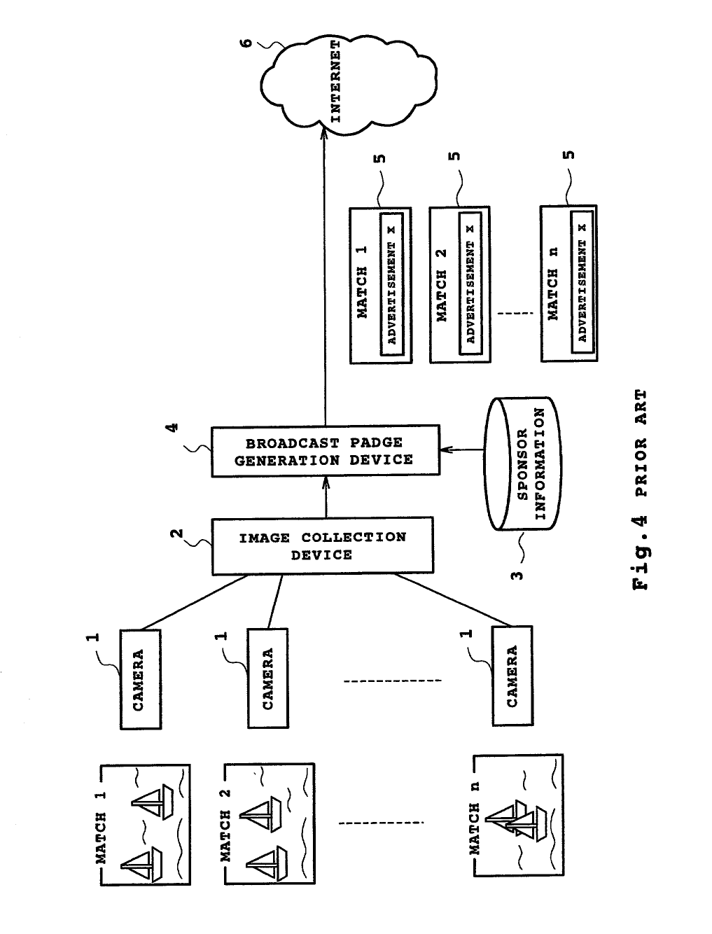

### DESCRIPTION OF THE PREFERRED EMBODIMENTS

Preferred embodiments of the present invention will be described referring to the accompanying drawings.

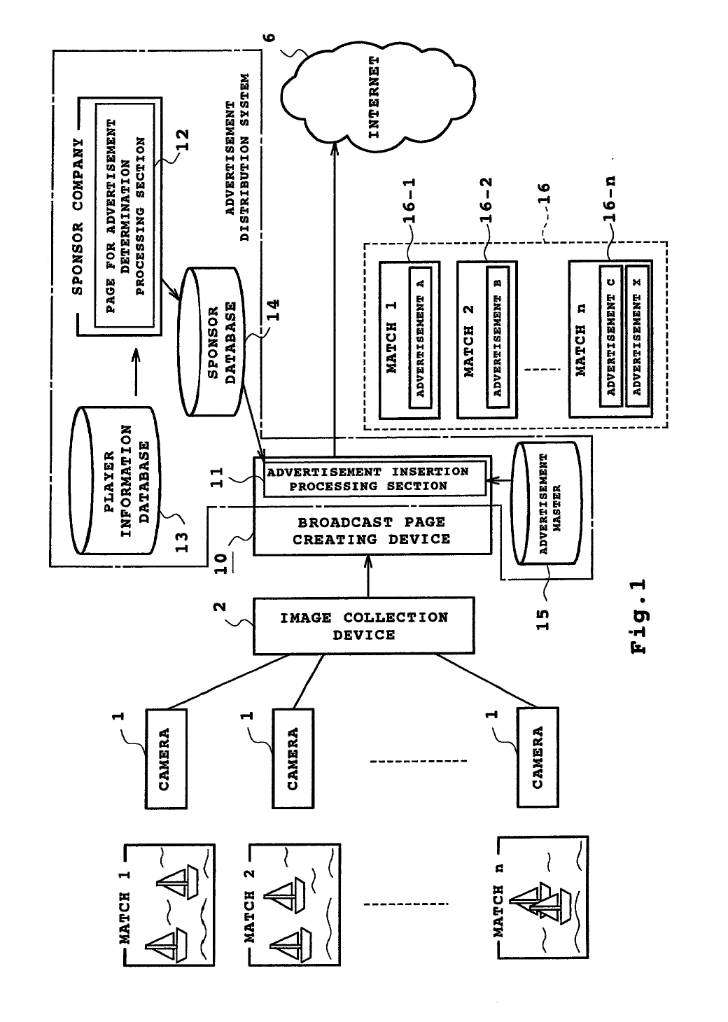

FIG. 1 is a schematic structural diagram of a sports broadcasting system employing a preferred embodiment of an advertisement distribution system for sports broadcasting according to the present invention. In this embodiment, match-style sports, such as the America's cup, will be broadcast. In the America's Cup, a plurality of yacht teams compete in an all-play-all match race system in determining a challenging yacht, in which two or more races may take place in parallel. Likewise, in soccer games during the Olympics, the World Cup, and so on, all participating teams compete in an all-play-all match system in the first preliminary round, in which two or more games may often take place in parallel in two or more stadiums. Referring to FIG. 1, the camera 1 is an image capturing device for shooting each game. It is assumed for brevity in this embodiment that one camera is assigned to each game, though in actual fact, two or more cameras may be assigned. The image collection device 2 collects images from the camera 1. The broadcast page creation device 10 creates broadcast pages based on the image data collected. In this embodiment, it is assumed for brevity that one broadcast page is created for each match. Viewers can watch the America's Cup via the Internet 6 while selecting a broadcast page airing a desired race from among a plurality of created broadcast pages.

An advertisement distribution system in this embodiment comprises an advertisement insertion processing section 11, mounted in the broadcast page creation device 10, a player information database 13, a sponsor database 14, and an advertisement master 15.

The broadcast page creation device 10 creates broadcast pages for airing the respective matches live. The advertisement insertion processing section 11 inserts advertisements into broadcast pages. The page for advertisement determination processing section 12 registers ID information of a company wishing to be a sponsor into the sponsor database 14 according to an input by the company.

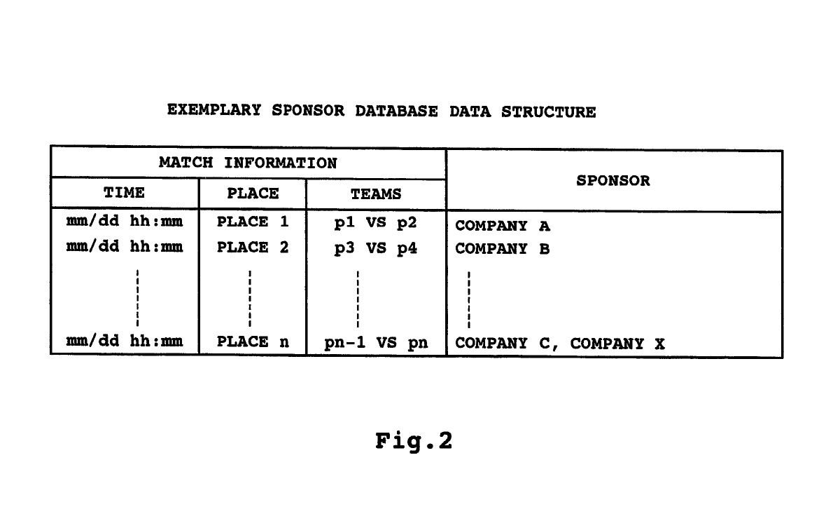

FIG. 2 is a diagram showing an exemplary data structure of a sponsor database 14 in this embodiment. The sponsor database 14 contains pre-registered match information on the respective matches to take place in the tournament. Match information includes the names of competing teams (clubs) and date and place for a match. The sponsor database 14 is also provided with a field corresponding to match information, for designating a sponsor, so that a company wishing to sponsor a particular match can register its ID information in the corresponding field via the page for advertisement determination processing section 12. Note that “content of competition” corresponds to a match in this embodiment in which each match is aired in each broadcast page.

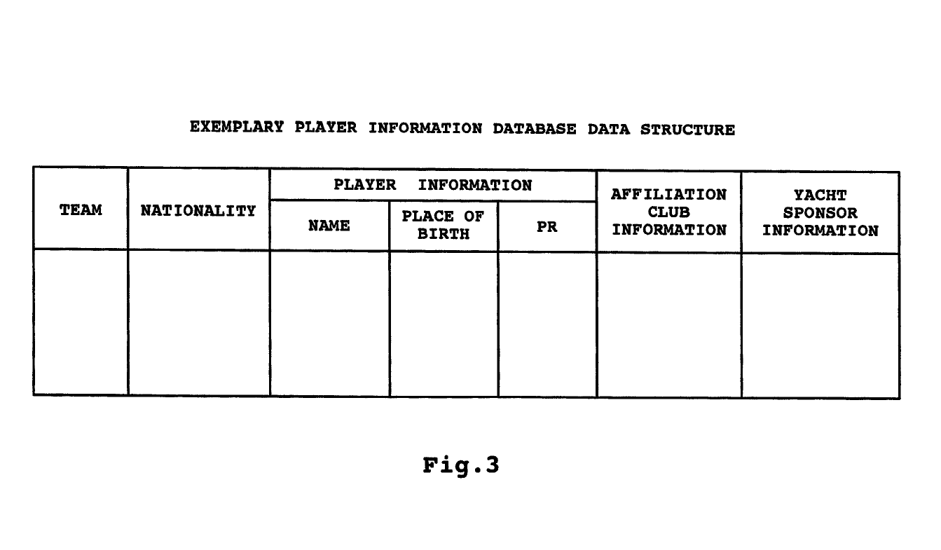

FIG. 3 is an exemplary data structure of a player information database 13. The player information database 13 contains pre-registered player information including a profile of a participating team or player. Here, the player information includes the name and nationality of a team (i.e., a competitor), affiliated club information, and yacht sponsor information (i.e., a list of companies sponsoring a relevant yacht) as this embodiment is directed to an inter-club match (i.e., in team unit). The name, a place of birth, a profile of each player of each team may additionally be registered. Player information may serve as a key for companies in deciding on a team to sponsor.

An advertisement master 15 is a database containing company advertisements for insertion into a broadcast page. Once a sponsor to a particular broadcast page is determined, the advertisement insertion processing section 11 extracts an advertisement of that company from the advertisement master 15 and inserts it into the relevant broadcast page.

In a sport broadcasting system of this embodiment, a broadcast page is created for every match using the above described sections. Viewers can select and watch a desired broadcast page. It is assumed that, in the selection of a particular broadcast page from among a plurality of broadcast pages, a viewer generally selects a match played by his favorite team or player or a team from his own country. That is, it is assumed that the preference of a viewer may be reflected in the selection of a broadcast page to be watched, and that there may be some relationship between a viewer and a team (such as them being from the same country, and so on) involved in a game the viewer has decided to watch.

This embodiment is characterized by the fact that an advertisement can be placed for every broadcast page, i.e., for every match. That is, whereas sponsors are conventionally raised to sponsor the whole tournament and sponsor advertisements are inserted into the respective broadcast pages airing respective matches, irrespective of the relationship between a match and a viewer, in this embodiment, sponsors are raised for every broadcast page (for every match) so that a sponsor can be determined for every match. As described above, a sponsor can be assigned to each live Internet broadcasting with a smaller coverage than that in a conventional method. This is beneficial for sponsoring companies in that more effective advertisement can be achieved, beneficial for tournament committees in that not only big sponsors but also many smaller sponsors can be raised, and beneficial for viewers in that they can watch advertisements of interest to them.

Next, operation of the preferred embodiment will be described. In the following description, it is assumed that sponsoring companies are already registered in the sponsor database 14 as they must be registered in advance to create a broadcast page having their advertisement. Registration into the sponsor database 14 will be described later in detail.

Respective matches carried out in parallel are shot each by each assigned camera 1. The image collection device 2 collects images of the respective matches from the assigned cameras 1. The broadcast page creation device 10 creates a broadcast page 16 for each match based on the collected images. These processes thus far are identical to the related art.

The advertisement insertion processing section 11 correlates broadcast pages 16 (1) to 16(n) with matches to be aired in the respective broadcast pages 16, and then specifies a sponsor to each broadcast page 16 (1) to 16 (n) according to the match information in the sponsor database 14. In the America's Cup, in which a place where a match takes place is known in advance, correspondence between a camera 1, a broadcast page 16, and a match can be easily known. The advertisement insertion processing section 11 extracts a sponsor advertisement to be inserted into a broadcast page 16 from the advertisement master 15, and inserts it into a relevant broadcast page 16 of the broadcast pages 16(1) to 16(n). For example, in the examples FIGS. 1 and 2, where a company A sponsors a match 1, advertisement A of the company A is inserted into a broadcast page 16-1 which airs the match 1. Likewise, where companies C and X sponsor a match n, advertisements of the companies C and X are inserted into the broadcast page 16(n) which airs the match n.

According to the embodiment, advertisements of different companies can be inserted into broadcast pages 16(1) to 16(n). This allows sponsor companies to advertise effectively. That is, when a Japanese yacht team competes against an American yacht team in race 1, a large portion of viewers of that race may be either Japanese or American people. Therefore, little advertisement effect may be expected for companies having no sales outlet either in Japan or the U.S. from having advertisement in a broadcast page of the race 1, except from the strategic view of enhancing notability. Meanwhile, when an Italian yacht team competes against a French yacht team in a race 2, a large advertisement effect may be expected for companies having sales outlets in Italy and/or France from having an advertisement in a broadcast page of the race 2. Conventionally, where sponsors are not specified for every match, companies wishing to obtain advertisement effects from an advertisement in a broadcast page for the race 2 may have no other choice but to unconditionally have an advertisement in a broadcast page for the race 1. In this embodiment, as sponsors are specified for every match, each company can place their advertisement only in a broadcast page selected with the expectation of producing larger advertisement effect.

In addition, when a contract fee is broken down into smaller units resulting from the reduction of an advertisement unit, tournament committees, who can now contract with each company for every match, can raise more sponsors and is no longer required to find a company capable of affording a large contract fee to ensure a running fee of the tournaments. Companies, who now do not necessarily have to sponsor the whole tournament in order to advertise, can reduce the contract fee they need to pay, and even companies incapable of affording an expensive contract fee can now be a sponsor and advertise.

Chances of having an advertisement for every match can be utilized not only for company advertisement but also for notification of information relating to that particular match. For example, an advertisement for recruiting new members to a yacht club involved in the ongoing match, as well as information addressing the club members, can be placed.

In addition, a more specific advertisement can be set, such as advertisement in the language of the country of the team in the ongoing match, by contriving the setting of the sponsor database 14 and the advertisement master 15.

It should be noted that, whereas the above embodiment is characterized by the fact that an advertisement is made for every match, other items, for example time, may be focused on in placing an advertisement. Specifically, placement of advertisements in all broadcast pages airing matches held at a particular date or time can be easily achieved.

In the following, registration of sponsor ID information in the sponsor database 14 will be described.

This embodiment is characterized by the fact that matches are focused on so that sponsors can be determined for every match. However, companies wishing to be a sponsor should still seize information on the tendency or preference of viewers of each match in order to achieve effective advertising. Regarding this point, reference to the match information in the sponsor database 14 of this embodiment, where opponent teams are registered along with their information, may help sponsoring companies in ascertaining, to some extent, the tendency and preference of the target viewers. For example, it can be easily anticipated that many of the viewers of an inter-country tournament will be those from the countries of the competing teams. This embodiment is further characterized by a player information database 13, which is provided to help companies to achieve effective advertising. That is, the player information database 13 contains player information as an exemplary index of efficiency or effectiveness expected from having an advertisement in a particular match (i.e., in a broadcast page).

Specifically, referring to FIG. 3, not only team information but also detailed information on each player of that team is registered in the player information database 13. A company wishing to be a sponsor may refer to the player information in determining a match to sponsor so that effective advertising can be attained. For example, in the case where a participating yacht carries a skipper from a different country from that of the yacht itself, many viewers from the skipper's country may also be expected. Companies may be able to anticipate such viewer tendency with reference to the player information database 13.

In the following, registration of sponsor ID information in the sponsor database 14 will be described.

In response to an input operation by a company operator, the page for advertisement determination processing section 12 causes display of the content of the player information database 13. The operator, referring to the displayed player information, specifies a team to sponsor. In response to the instruction by the operator, the page for advertisement determination processing section 12 causes display of a screen for registration in the sponsor database 14. When the operator designates a race (a match) involving the team specified, with reference to the match information displayed, the page for advertisement determination processing section 12 registers ID information of that company in the sponsor database 14 so as to correspond to the selected match. Accordingly, the advertisement insertion processing section 11 inserts an advertisement of that company into a broadcasting page airing their sponsoring match.

As described above, presenting player information to companies may allow them to sponsor an appropriate match to achieve effective advertising even though PR persons from the companies have only poor knowledge on the players of the sports to be aired or when players are from different countries to that of the affiliating team.

It should be noted that, whereas a company designates a match to sponsor in the above, the page for advertisement determination processing section 12 may encourage a company operator to designate a team with reference to the player information database 13 so that the company can sponsor all matches involving the designated team. Specifically, the page for advertisement determination processing section 12 searches the sponsor database 14 based on the team designated with reference to the player information database 13, and automatically registers the relevant company ID information into the sponsor database 14 so as to correspond to all matches involving the designated team.

In the embodiment, for brevity, no condition is set in registering company ID information in the sponsor database 14. However, in actual operation, it is desirable to set a condition under which a company can sponsor a match, such as a sponsor fee, the maximum number of advertisements, conflicts with a yacht sponsor, and so on.

It should be noted that, whereas the present invention has been described in the context of team sports, such as the America's Cup, the Soccer World Cup, and so on, obviously, the present invention can be applied to sports matches contested between individuals without problems.

The present invention can also be applied to a sport other than match type sports, such as a sport where players compete at the same time, such as a marathon. In this case, the player information database 13 contains a profile of each runner, information on his/her affiliated team or company, and so on. The sponsor database 14 then contains player ID information, rather than match information, as content of the competition. For match-style games, as a place where a game takes place is known in advance, correspondence between a match and a camera 1 may be known in advance. This allows easy correspondence between the respective broadcast pages 16(1) to 16(n) and marches to be aired. For a marathon, on the other hand, some contrivance must be made to correlate the respective broadcast pages 16(1) to 16(n) with runners being aired. For example, a dedicated camera may be assigned to a targeted competitor; an input means for specifying a competitor shot by a camera 1 may be provided; or a means for automatically reading the athlete number may be provided. Alternatively, an advertisement may be assigned not to a competitor but to a fixed element, such as a district (section).

As described above, in this embodiment, a sponsor database 14 is provided to achieve smaller advertisement units, and a player database 13 is provided to anticipate effects to be obtained from having an advertisement in respective broadcasting pages. Therefore, the player information database 13 and the sponsor database 14 may be properly modified into appropriate data structures depending on the type of sports for broadcasting.

The present invention is characterized by the fact that sponsors can be set not for the entire tournament but for every broadcast page. Methods for creating broadcast pages, displaying advertisements in broadcast pages, and conditions as to contract fees are excluded from the gist of the present invention.

What is claimed is:

1. A method for distributing advertisements in sports broadcasting, employed in a sports broadcasting system for live broadcasting of a sports competition in which a plurality of teams or players compete in parallel, through collecting image data obtained using a plurality of image capturing devices, creating a plurality of broadcast pages based on the image data collected for disclosure via the Internet, and having a viewer select a desired page to watch from the plurality of broadcast pages, the method comprising the step of:
setting advertisements to be shown in each broadcast page, for every broadcast page.

2. A method for distributing advertisements in sports broadcasting, employed in a sport broadcasting system for live broadcasting of a sports competition in which a plurality of teams or players compete in parallel, through collecting image data obtained using a plurality of image capturing devices, creating a plurality of broadcast pages based on the image data collected for disclosure via the Internet, and having a viewer select a desired page to watch from the plurality of broadcast pages, the method comprising the step of:
recognizing a team or a player to be aired in each broadcast page created, and
setting advertisements to be shown corresponding to the team or the player.

3. An advertisement distribution system, employed in a sports broadcasting system for live broadcasting of a sports competition in which a plurality of teams or players compete in parallel, through collecting image data obtained using a plurality of image capturing devices, creating a plurality of broadcast pages based on the image data collected for disclosure via the Internet, and having a viewer select a desired page to watch from the plurality of broadcast pages, for distributing advertisement in sports broadcasting by inserting into a broadcast page created, comprising:
advertisement insertion processing means for inserting an advertisement into a broadcast page;
a player information database containing registered player information including a profile of a participating team or player;
a sponsor database containing content of a competition to be aired in each broadcast page, and sponsor ID information of a sponsor placing an advertisement, both being registered in correspondence with each other,
page for advertisement determination processing means for causing display of the player information registered in the player information database, letting a sponsor designate a team or a player for which to place an advertisement, and registering the sponsor ID information in the sponsor database so as to correspond to a broadcast page airing the content of competition involving the team or player designated,
wherein
the advertisement insertion processing means specifies a sponsor for each broadcast page created, based on content set in the sponsor database, and inserts an advertisement of the sponsor specified into a corresponding broadcast page.

4. An advertisement distribution system, employed in a sports broadcasting system for live broadcasting of a sports competition in which a plurality of matches involving teams or competitors are carried out in parallel, through collecting image data obtained using a plurality of image capturing devices, creating a plurality of broadcast pages based on the image data collected for disclosure via the Internet, and having a viewer select a desired page to watch from the plurality of broadcast pages created, for distributing advertisement in a sport broadcasting by inserting into a broadcast page created, comprising:
advertisement insertion processing means for inserting an advertisement to a broadcast page airing each match;
a sponsor database containing sponsor ID information so as to correspond to match information on each match; and
page for advertisement determination processing means for registering sponsor ID information to the sponsor database,
wherein
the advertisement insertion processing means specifies a sponsor for each match to be aired in each broadcast page, based on content set in the sponsor database, and inserts an advertisement of the sponsor specified into a corresponding broadcast page.

5. An advertisement distribution system according to claim 4, wherein the page for advertisement determination processing means specifies a match in the sponsor database, which involves a team or a player designated by the sponsor, and registers the sponsor ID information in the sponsor database so as to correspond to the match specified.

6. An advertisement distribution system according to claim 4, further comprising a player information database containing player information including a profile of an involved team or player, wherein the page for advertisement determination processing means displays player information registered in the player information database, lets the sponsor designate a team or a player for which to place an advertisement, specifies a match in the sponsor data base, which involves the team or player designated by the sponsor, and registers in the sponsor database the sponsor ID information so as to correspond to a broadcast page airing content of the competition involving the team or player designated.
